(19) United States
(12) Patent Application Publication
(10) Pub. No.: US 2003/0035939 A1
(43) Pub. Date: Feb. 20, 2003

(54) Windowpane for head up display and method for manufacturing the same

(75) Inventors: Takashi Muromachi, Osaka (JP); Hideki Okamoto, Osaka (JP)

Correspondence Address: MERCHANT & GOULD PC, P.O. BOX 2903, MINNEAPOLIS, MN, 55402-0903, US

(73) Assignee: NIPPON SHEET GLASS CO., LTD., Osaka (JP)

(21) Appl. No.: 10/213,013

(22) Filed: Aug. 5, 2002

(30) Foreign Application Priority Data
Aug. 6, 2001 (JP) 2001-238093
Feb. 19, 2002 (JP) 2002-041951

(51) Int. Cl. B32B 17/06; B05D 5/06

(52) U.S. Cl. 428/212; 428/428; 428/432; 427/162

(57) ABSTRACT

The present invention provides a windowpane for a vehicle that has a low-reflectance film in which the reflection of obliquely incident light can be suppressed and that is provided with a combiner for a head-up display combiner. The windowpane includes a glass plate and a low-reflectance film formed on a surface of the glass plate. The low-reflectance film includes a first layer on the glass plate and a second layer on the first layer, and the first layer has a refractive index of 1.75 to 2.40 and a film thickness of 90 nm to 130 nm, and the second layer has a refractive index of 1.4 to 1.47 and a film thickness of 80 nm to 110 nm. The second layer is prevented from being formed in a predetermined region and thereby the first layer in the predetermined region is exposed to serve as a reflection enhancing film and to allow the first layer in said predetermined region to be used as the head-up display combiner.

### FIELD OF THE INVENTION

The present invention relates to a windowpane for a vehicle having a combiner for a head-up display (hereinafter referred to simply as HUD). Particularly, the present invention relates to a windowpane that is used for a windshield glass of an automobile and is provided with a low-reflectance film.

### BACKGROUND OF THE INVENTION

JP-A-6(1994)-305775 discloses a vehicle windowpane characterized in that a low-reflectance thin film is formed on the surface of a glass substrate and includes a plurality of thin films, and a thin film as the first layer that is in direct contact with the glass surface is allowed to be exposed at least in its predetermined region, and the thin film formed in the predetermined region has a higher refractive index than a relatively low refractive index of a thin film as the outermost layer. In addition, JP-A-6(1994)-305775 describes that thin films with different refractive indices are formed and stacked in two or three layers to form the low-reflectance thin film and the vehicle window glass with the above-mentioned structure can be used as a combiner glass plate for a HUD.

JP-A-6(1994)-340450 discloses a vehicle windowpane characterized in that a low-reflectance thin film is formed on the surface of a glass substrate and includes a plurality of thin films, and a thin film as the first layer that is in direct contact with the glass surface is allowed to be exposed at least in its predetermined region, and the thin film formed in the predetermined region has a higher refractive index than a relatively low refractive index of a thin film as the outermost layer. The whole or a part of the predetermined region is coated with a thin film of at least one layer stacked thereon. In addition, it is described that the predetermined region coated with at least a single layer film stacked on the low-reflectance thin film is formed of a wavelength-selective reflective film, and in the predetermined region at least in which the thin film as the first layer of the low-reflectance thin film that is in direct contact with the glass surface is allowed to be exposed is formed of a wavelength-nonselective reflective film.

Moreover, U.S. Pat. No. 5,496,621, based on the patent applications published as the above-mentioned JP-A-6(1994)-305775 and JP-A-6(1994)-340450, includes numerical limitations such as a refractive index of 1.80 to 2.10 and a film thickness of 70 to 230 nm as to the first layer, a refractive index of 1.40 to 1.50 and a film thickness of 110 to 130 nm as to the second layer, and the like.

JP-Z-2500821 discloses a transparent reflection enhancing film as a HUD combiner that is made of metal oxide with a refractive index of 1.8 to 2.3 to have an optical film thickness of 400 to 1500 A (40 to 150 nm).

In JP-A-6(1994)-305775, with respect to the low-reflectance film having a two-layer structure, the only numerical values described as examples include a refractive index of 1.8 to 2.1 and a film thickness of 700 to 2300 Å(70 to 230 nm) as to the first layer and a refractive index n2 of 1.4 to 1.5 and a film thickness d₂ of 1100 to 1300 Å(110 to 130 nm) as to the second layer.

Similarly in JP-A-6(1994)-340450, with respect to the low-reflectance film having a two-layer structure, only numerical values in ranges similar to those in JP-A-6(1994)-305775 are given as examples.

In JP-A-6(1994)-305775 and JP-A-6(1994)-340450 above, it is necessary to form the low-reflectance film on only one surface of the glass plate and therefore only one surface of the glass plate is required to be covered overall with a masking tape.

In addition, as the method for allowing the thin film as the first layer to be exposed at least in its predetermined region, a peeling process is needed as follows: first, a low-reflectance film is formed by a dip method, and an alkoxide-decomposing paste is screen-printed in an unnecessary region of the second layer and then is baked. Afterward, the alkoxide- decomposing paste that sticks to the region is removed with sodium hydroxide and sulfuric acid.

In the peeling process, it is difficult to remove the second layer alone completely. Even if it was removed completely, a number of steps are required, resulting in a cost increase.

### SUMMARY OF THE INVENTION

The present invention is intended to provide a windowpane for a vehicle, provided with a HUD combiner. The windowpane includes a glass plate and a low-reflectance film formed on a surface of the glass plate. The low-reflectance film includes a first layer on the glass plate and a second layer on the first layer, and the first layer has a refractive index of 1.75 to 2.40, preferably 1.75 to 2.20 and a film thickness of 90 nm to 130 nm, and the second layer has a refractive index of 1.4 to 1.47 and a film thickness of 80 nm to 110 nm. The second layer is prevented from being formed in a predetermined region and thereby the first layer in said predetermined region is exposed to serve as a reflection enhancing film and to allow the first layer in said predetermined region to be used as the head-up display combiner. Here, the film thickness denotes a physical film thickness, not an optical film thickness.

The present invention also provides a method that can be suitable for manufacturing the windowpane for a vehicle. The method includes a step of coating a first sol-gel solution for the first layer onto the glass plate, and a step of coating a second sol-gel solution for the second layer onto the first layer. The second sol-gel solution is applied by flexography using a flexographic plate that has a recessed portion, whereby the second layer is prevented from being formed in a predetermined region that corresponds to the recessed portion. Thus, the first layer in the predetermined region is exposed to serve as a reflection enhancing film and to allow the first layer in the predetermined region to be used as the head-up display combiner.

The low-reflectance film can suppress the reflection of obliquely incident light and provides a HUD combiner.

### BRIEF DESCRIPTION OF THE DRAWINGS

FIG. 1 is a plan view of an embodiment of a windowpane according to the present invention.

FIG. 2 is a sectional view for explaining flexography.

FIGS. 3A and 3B are drawings for explaining shapes of flexographic plates that can be used for the first and second layers of the present invention, respectively.

FIG. 4 is a sectional view of an example of a glass plate for a windowpane according to the present invention.

FIG. 5 is a drawing for explaining a modified example including gradation dots formed around the combiner part.

FIG. 6 is a sectional view of an example of a glass plate for a windowpane according to the present invention.

### DETAILED DESCRIPTION OF THE INVENTION

In the present invention, with respect to light incident at an angle of 60°, the windowpane preferably has a visible light reflectance of 11% or less at the surface where the low-reflectance film is formed and a visible light reflectance of at least 15% in the predetermined region (combiner part).

The glass plate can be a laminated glass. The laminated glass plate preferably includes two green glass plates bonded together with an intermediate film. Here, a green glass plate denotes a glass plate composed of a glass composition that includes at least 0.5wt%, preferably at least 0.52wt% of iron oxide based on Fe₂O_{3.} A clear glass denotes a glass plate composed of a glass composition that includes less than 0.2wt% of iron oxide based on Fe₂O_{3.}

The first layer and the second layer may be formed of metal oxide. The first layer preferably includes TiO₂ and/or SiO₂ and the second layer preferably includes SiO₂ as a main component. Here, a main component denotes a component of 50wt% or more.

When the first and second layers are formed by a sol-gel method, the first layer preferably has a mole ratio of TiO_{2:}SiO₂ is in a range of 40:60 to 100:0, and the second layer preferably is made of SiO₂. When the first and second layers are formed by sputtering, the first layer preferably has a mole ratio of TiO_{2:}SiO₂ is in a range of 31:69 to 100:0, and the second layer preferably is made of SiO₂.

The metal oxide for the reflection enhancing film is not particularly limited as long as it has a refractive index within the above-mentioned range. The metal oxide should be transparent and may be made of not only a single component but also a mixture of at least two components.

Generally, low-reflectance films formed on transparent substrates are classified into some groups according to the number of layers included therein. They may be classified into a single-layer structure, a two-layer structure, a three-layer structure, and a multilayer (our or more layer) structure.

First of all, as a low-reflectance film with the single-layer structure, for example, on a glass plate as a transparent substrate is formed a film with a lower refractive index than that of the glass plate. Examples of the practical material with a low refractive index include MgF₂ and SiO₂.

In such a single-layer structure, however, an antireflection effect might not be obtained to a sufficient degree. Hence, a low-reflectance film with the two-layer structure is used, which includes a combination of two layers having higher and lower refractive indices than that of the glass plate, respectively.

When the antireflection effect cannot be obtained to a sufficient degree even with the two-layer structure employed, a low-reflectance film may be used that has a three-layer structure including layers with low, middle, and high refractive indices, respectively, or has a structure including four layers or more.

In any case, a layer with a lower refractive index than that of the transparent substrate is formed as the top layer of the low-reflectance film. For instance, only MgF₂ and SiO₂ described above are practical as the material with a lower refractive index than that of the glass plate. However, the use of MgF₂ results in the formation of a layer with a low refractive index having poor durability and weather resistance and it cannot endure heating in a glass plate-bending step. Hence, only SiO₂ is applicable to such a use.

Here, when consideration is given to the case where a low-reflectance film is applied to a bent glass plate for a vehicle, it is preferable in terms of thickness uniformity or the like that a low-reflectance film be formed on a glass plate that is in a flat state and then the glass plate be heated to be bent. Thus, the method of the present invention may further include a step of bending the glass plate with the low-reflectance film and another glass plate, and a step of laminating these glass plates with an intermediate film.

One preferable method for coating a wide area with SiO₂ at low cost is roller coating. In this case, preferably, a SiO₂ layer is formed by a sol-gel process. In addition, the SiO₂ layer may be formed to be in a porous state to allow an apparent refractive index to be decreased. Furthermore, inorganic minute particles with a lower refractive index may be mixed into a SiO₂ layer to decrease its refractive index. The decrease in refractive index of the second layer results in an increase in the antireflection effect. In this case, the second layer may contain B₂O_{3,} Al_{2O}₃ or other components in addition to SiO₂ as a main component.

With a low-reflectance film with the two-layer structure having a considerable antireflection effect that is a relatively simple film structure, the refractive index of a material with a high refractive index n₁ that can be combined with SiO₂ having a refractive index n₂ of 1.46 as a material with a low refractive index is calculated. An example of the relationship between n₁ and n₂ is expressed by the following formula:

n₁=[(n₂)² ×n_{g/n}ₒ]^{½},

wherein n_{g} denotes a refractive index of glass (=1.52), and n₃ indicates a refractive index of the air (=1.0). The refractive index n₁ is determined from this formula to be 1.80.

There is no suitable material having a refractive index n₁ around 1.80 among single materials that can be used to form a film by the sol-gel process. Hence, it is considered to use a layer made of a mixture of TiO₂ with a refractive index n of 2.2 and SiO₂ with a refractive index n of 1.46, both of which can be used to form a film by the sol-gel process. Furthermore, ZrO₂ with a refractive index n of 1.95, CeO₂, or Bi_{2O}₃ may be added to allow a layer with a high refractive index to be formed.

The low-reflectance film composed of two layers that is used in the present invention is designed so as to have a function of reducing the reflection of obliquely incident light. Moreover, the refractive index and film thickness of the first layer of the low-reflectance film composed of two layers are specified so that the first layer also can be utilized as a HUD combiner.

The refractive index and film thickness of the second layer also are designed with consideration given to the refractive index and film thickness of the first layer so that the second layer also functions as a low-reflectance film. It also is taken into consideration that the low-reflectance film as a whole is allowed to have a neutral color tone.

In the windowpane, the visible light reflectance at the film surface of the low-reflectance film can be set to be 11% or lower with respect to light incident at an angle of 60°. Such a reflectance permits a reflection reducing effect to be obtained when the windowpane is used as a windshield.

In the windowpane, the visible light reflectance at the film surface of the combiner part can be set to be at least 15%. Such a reflectance allows the part to function as a combiner.

With respect to the above mentioned low-reflectance film that reduces the reflection of obliquely incident light, the present inventors disclose, as the invention described in claim 1 in JP-A-2000-256042, the disclosure of which is incorporated herein by reference, a low-reflectance glass article for an automobile that is formed by coating and stacking of a thin film as the first layer viewed from a glass surface side with a refractive index (n₁) of 1.65 to 2.20 and a film thickness of 110 to 150 nm on at least one surface of a transparent glass substrate. A thin film as the second layer contains silica as a main component and has a refractive index (n₂) of 1.37 to 1.49 and a film thickness of 81 to 100 nm is formed on the thin film as the first layer, and that allows light reflected from the low-reflectance glass article when visible light is incident on its film surface side at angles of 12 and 60 degrees to have an excitation purity of 22% or lower and 10% or lower, respectively.

Furthermore, as to a glass plate provided with a function of reducing the reflection of obliquely incident light, the following is disclosed in JP-A-8(1996)-152501 for the purpose of obtaining a glass plate that is friendly to the environment and human beings. The intention is to diminish a phenomenon in which a dashboard or its surroundings are mirrored therein and a sense of glare for human and the environment, improve viewability therethrough for a driver, and improve safety through prevention of misconception, eye fatigue, or the like, using a thin film that reduces reflection, causes less coloration of interference colors, and has high durability when using the glass plate as a windshield.

That is, a reflection reducing glass plate for a vehicle is formed of a thin film with a refractive index of 1.7 to 1.8 and a film thickness of 90 to 110 nm as the first layer viewed from the glass surface side and a thin film with a refractive index of 1.4 to 1.5 and a film thickness of 105 to 130 nm as the second layer that are stacked by coating on at least one surface of a transparent glass substrate. In the reflection reducing glass plate for a vehicle, the reflectance of the surface of the film thus stacked as the second layer with respect to light that is incident at an angle of 50 to 70° to a vertical line of the surface to be reflected is allowed to decrease by 4.5 to 6.5% as compared to the reflectance of the glass surface, and the excitation purity of the reflected light with respect to the above-mentioned light that is incident at an angle of 50 to 70° is set to be 18% or lower.

### Preparation of Coating Solution

Initially, 500 g of ethyl silicate 40 (COLCOAT Co., LTD) was hydrolyzed with 410 g of ethylcellosolve and 90 g of 0.1 mol/L hydrochloric acid, which further was stirred. Thus, a solution A was prepared.

Next, 65.5 g of titanium tetraisopropoxide and 64.1 g of acetylacetone were mixed together and thereby a solution B was prepared.

These solutions A and B were mixed together at a ratio of 1:2.4, which then was diluted suitably with an ethylcellosolve solvent. Thus, a coating solution C was prepared.

Furthermore, the solution A was diluted suitably with an ethylcellosolve solvent and thereby a solution D was prepared.

When the ratio of TiO_{2:}SiO₂ is controlled so as to be in the range of 40:60 to 100:0 in terms of a mole ratio, the refractive index n₁ of a layer made of a mixture of TiO₂ and SiO₂ can be set in the range of 1.75 to 2.20.

In the sol-gel process, TiO₂ and SiO₂ are used suitably since their respective alkoxides as starting materials can be mixed with each other at various mixture ratios and the refractive index of a mixed film thus obtained can be controlled freely. This mixed film is excellent in durability and thus is preferable. In addition, the alkoxides as starting materials of TiO₂ and SiO₂ both are used suitably since they are stable, have high film formability, and allow a homogeneous film to be obtained easily. Furthermore, ZrO₂ (n=1.95) can be used to form a film by the sol-gel process and may be mixed suitably with TiO₂ and SiO₂ as required.

Examples of titanium alkoxide include titanium methoxide, titanium ethoxide, titanium n-propoxide, titanium n-butoxide, titanium isobutoxide, titanium methoxypropoxide, titanium stearyloxide, and titanium 2-ethylhexyoxide. Examples of titanium alkoxide halide such as titanium alkoxide chloride include titanium chloride trisopropoxide and titanium dichloride diethoxide.

Examples of silicon alkoxide include silicon methoxide, silicon ethoxide, and oligomers thereof.

When using a vapor deposition method such as sputtering, materials may be used including ThO₂ (n =1.8), SnO₂ (n =1.9), SiO (n =1.7 to 2.0), ZrO₂ (n =2.1), CeO₂ (n =2.2), TiO₂ (n =2.4), and the like. When a film is formed using TiO₂ by the sol-gel process described above, only a film with a refractive index n of about 2.2 is obtained. When a film is formed using TiO₂ by this sputtering technique, however, a film with a refractive index n of about 2.4 is obtained.

When the refractive index of the reflection enhancing film is below 1.7, a reflectance required for a combiner cannot be obtained. In addition, it is industrially difficult to obtain a reflection enhancing film with a refractive index exceeding 2.4.

### Example 1

Soda-lime silicate glass plates (green glass plates) that include about 0.53wt% of iron oxide (counted as Fe₂O₃) were prepared by a float glass process. These glass plates were cut into a predetermined size and washed. One of these glass plates was coated with the above-mentioned coating solution C.

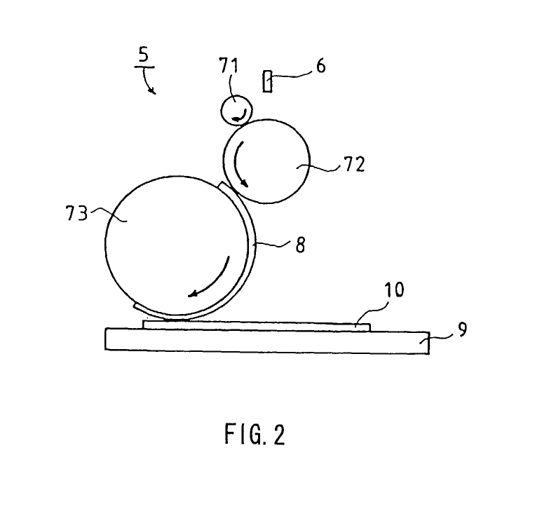

FIG. 2 shows a flexographic printer 5 used for the coating. A coating solution is supplied from a dispenser 6 onto a glass plate 10 on a carrier table 9 via an anilox roller 72 and a flexographic plate 8 on a printer roller 73. A doctor roll 71 prevents the coating solution from being excessively supplied.

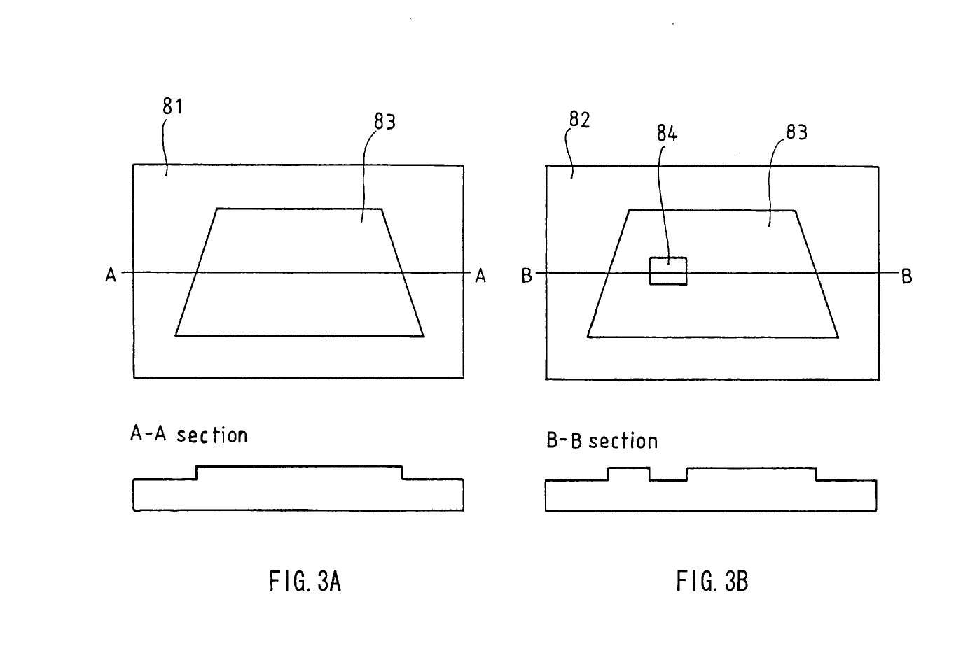

FIG. 3A schematically shows a flexographic plate 81 used here that has a printing face 83. This glass plate coated with the coating solution C was dried at about 300° C. Thus, a first sol-gel solution was applied.

Next, the whole surface of this glass plate also was coated with the coating solution D by flexography. In this case, a region 84 in a printing face 83 of a flexographic plate 82 corresponding to a region of the glass plate where a combiner was to be formed was recessed so that the coating solution D was not applied thereto. The flexographic plate 82 used here is shown in FIG. 3B schematically. After coating, the glass plate was dried at about 300° C. Thus, the second sol-gel solution was applied. As a result, the whole principal surface of the glass plate was coated with the coating solution D through an printing face 83, except the region to be a combiner.

This glass plate was baked at 620 to 630° C and then was subjected to bending formation to be formed as a glass plate for an automobile. The bending formation was carried out as follows: the above-mentioned glass plate and another glass plate processed to have a similar shape thereto were stacked on top of each other, then were placed on a sagging die, and were heated in a furnace to be bent by their own weight.

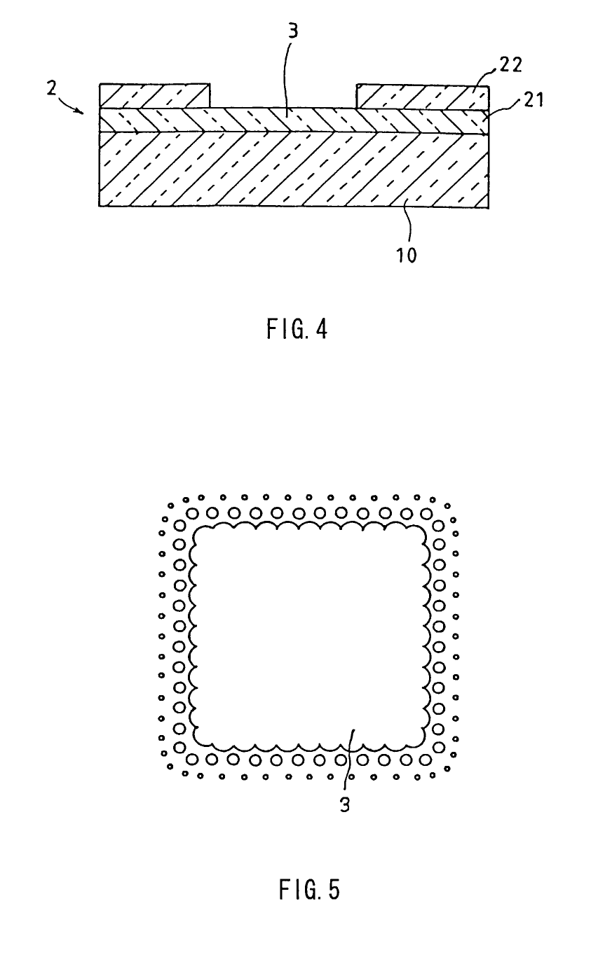

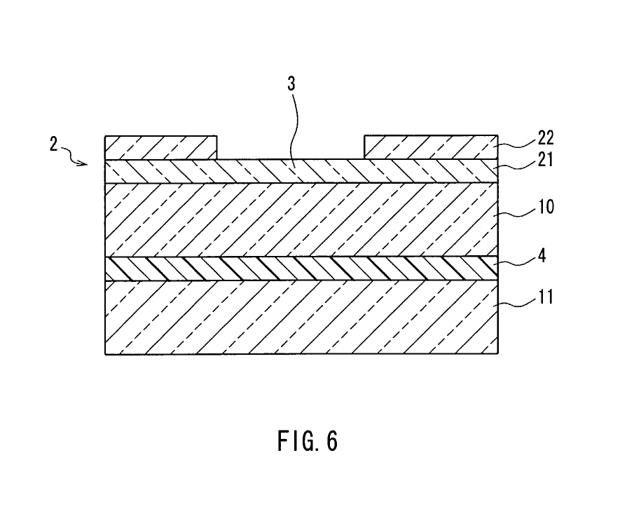

Thus, a glass plate was obtained that was provided with a low-reflectance film having a two-layer structure formed of the first layer with a refractive index n₁ of about 1.9 and a film thickness d1 of about 110 nm and a second layer with a refractive index n₂ of about 1.44 and a film thickness d₂ of about 90 nm. The HUD combiner part was not coated with the second layer and thus was formed of a film composed of the first layer alone. FIG. 4 shows a schematic view of the cross-section of this combiner part 3 of a surface of the glass plate 10. The boundary portion of the combiner part 3 at the surface of the low-reflectance film 21, 22 was formed in a predetermined position accurately and had an excellent appearance.

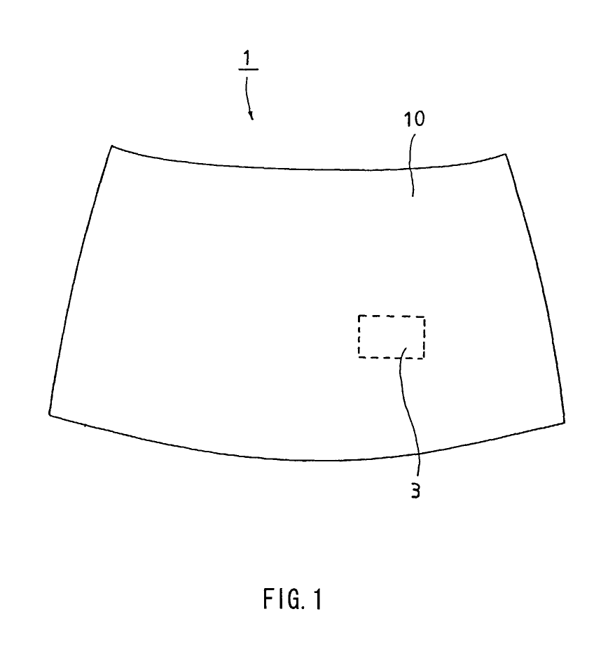

Furthermore, using a PVB film as an interlayer, an ordinal lamination process was carried out with the side of the low-reflectance film 21, 22 of the glass plate 10 placed to be used inside a vehicle and the above-mentioned another glass plate 11 placed to be used outside the vehicle. Thus, a HUD combiner-provided laminated was obtained (see FIG. 1). The optical performance of the laminated glass thus obtained is indicated in Table 1. The transmissivity and the reflectance indicated in Table 1 were measured with light incident at an angle of 0° and with light incident at an angle of 60°, respectively. With respect to the combiner part, the reflectance shown in Table 1 is of the film surface alone.

TABLE 1

| | Visible Light | Visible Light |
|---|---|---|
| | Transmissivity (%) | Reflectance (%) |
| Low-Reflectance Film | 79.4 | 9.9 |
| Combiner Part | 71.3 | 18.9 |

As is apparent from Table 1, the combiner part has an increased reflectance and thereby it was proved that the first layer serves as a reflection enhancing film. Consequently, it is possible to make this part function as a combiner.

Thus, the HUD combiner-provided low-reflectance film can be obtained by the low-reflectance film formation step alone. This was achieved by the process in which the two layers of the low-reflectance film were formed by flexography and the combiner part was prevented from being coated during the coating step for forming the second layer.

### Example 2

The above-mentioned coating solutions A and B were mixed together at a ratio of 1:10.8, which then was diluted suitably with an ethylcellosolve solvent. Thus, a coating solution C2 was prepared. In Example 2, a laminated glass with a low-reflectance film having a two-layer structure was obtained by the same manner as in Example 1 except that the coating solution C2 was used instead of the coating solution C. The low-reflectance film included a first layer with a refractive index n₁ of about 2.1 and a film thickness d₁ of about 110 nm and a second layer with a refractive index n₂ of about 1.44 and a film thickness d₂ of about 90 nm. The result is shown in Table 2.

TABLE 2

| | Visible Light | Visible Light |
|---|---|---|
| | Transmissivity (%) | Reflectance (%) |
| Low-Reflectance Film | 78.9 | 9.7 |
| Combiner Part | 71.3 | 20.3 |

In Comparative Example 1, the above-mentioned solutions A and B were mixed together at a ratio of 1:4.8, which then was diluted suitably with an ethylcellosolve solvent. Thus, a coating solution was prepared.

Initially, a first layer was formed with the coating solution c, and then a second layer was formed with the coating solution D. In this case, the first layer had a refractive index n₁ of about 2.0 and a film thickness d₁ of about ₆₀ nm and the second layer had a refractive index n₂ of about 1.44 and a film thickness d₂ of about 90 nm. Except for this, the same steps as those in the above-mentioned examples were carried out to produce a HUD combiner-provided laminated glass for a vehicle. The optical performance of the laminated glass plate thus obtained is shown in Table 3. The measurement conditions are the same as those in the above-mentioned examples.

TABLE 3

| | Visible Light | Visible Light |
|---|---|---|
| | Transmissivity (%) | Reflectance (%) |
| Low-Reflectance Film | 77.9 | 15.6 |
| Combiner Part | 65.0 | 22.3 |

### Comparative Example 2

In Comparative Example 2, a laminated glass was obtained by the same manner as in Comparative Example 1 except that the film thickness of the first layer was set to be 140 nm. The result is shown in Table 4.

TABLE 4

| | Visible Light | Visible Light |
|---|---|---|
| | Transmissivity (%) | Reflectance (%) |
| Low-Reflectance Film | 78.5 | 9.7 |
| Combiner Part | 76.1 | 12.2 |

### Modified Example

FIG. 5 shows an example with gradation dots formed around a combiner to make its presence inconspicuous.

As described above, in a HUD combiner-provided windowpane for a vehicle according to the present invention, the refractive index n₁ and film thickness d₁ of the first layer of the low-reflectance film are set to be in the range of 1.75 to 2.40 and in the range of 90 to 130 nm, respectively. Hence, the region where the second layer is not formed has an increased reflectance and thus is allowed to function as a combiner. Furthermore, the low-reflectance film can be obtained without increasing the number of steps and thus the HUD combiner-provided windowpane can be provided at low cost.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A windowpane for a vehicle, provided with a head-up display combiner, comprising:
a glass plate; and
a low-reflectance film formed on a surface of the glass plate,
wherein the low-reflectance film comprises a first layer on the glass plate and a second layer on the first layer,
wherein the first layer has a refractive index of 1.75 to 2.40 and a film thickness of 90 nm to 130 nm, and the second layer has a refractive index of 1.4 to 1.47 and a film thickness of 80 nm to 110 nm, and
wherein the second layer is prevented from being formed in a predetermined region and thereby the first layer in said predetermined region is exposed to serve as a reflection enhancing film and to allow the first layer in said predetermined region to be used as the head-up display combiner.

2. The windowpane according to claim 1, wherein with respect to light incident at an angle of 60°, the windowpane has a visible light reflectance of 11% or lower at the surface where the low-reflectance film is formed and a visible light reflectance of at least 15% in said predetermined region.

3. The windowpane according to claim 1, wherein the glass plate is a laminated glass.

4. The windowpane according to claim 3, wherein the laminated glass comprises two green glass plates bonded together with an intermediate film.

5. The windowpane according to claim 1, wherein the first layer comprises TiO₂ and/or SiO₂ and the second layer comprises SiO₂ as a main component.

6. The windowpane according to claim 5, wherein the first layer is formed by a sol-gel process, a mole ratio of TiO₂ :SiO₂ is in a range of 40:60 to 100:0, and the second layer is made of SiO₂.

7. The windowpane according to claim 5, wherein the first layer is formed by sputtering, a mole ratio of TiO₂:SiO₂ is in a range of 31:69 to 100:0, and the second layer is made of SiO₂.

8. A method of manufacturing a windowpane for a vehicle, provided with a head-up display combiner, the windowpane comprising a glass plate and a low-reflectance film formed on a surface of the glass plate,
wherein the low-reflectance film comprises a first layer on the glass plate and a second layer on the first layer, and wherein the first layer has a refractive index of 1.75 to 2.20 and a film thickness of 90 nm to 130 nm, and the second layer has a refractive index of 1.4 to 1.47 and a film thickness of 80 nm to 110 nm, the method comprising:
coating a first sol-gel solution for the first layer onto the glass plate, and
coating a second sol-gel solution for the second layer onto the first layer,
wherein the second sol-gel solution is applied by flexography using a flexographic plate that has a recessed portion,
whereby the second layer is prevented from being formed in a predetermined region that corresponds to the recessed portion and thereby the first layer in said predetermined region is exposed to serve as an reflection enhancing film and to allow the first layer in said predetermined region to be used as the head-up display combiner.

9. The method according to claim 8, wherein the first layer comprises TiO₂ and/or SiO₂ and the second layer comprises SiO₂ as a main component.

10. The method according to claim 9, wherein the first layer is formed by a sol-gel process, a mole ratio of TiO_{2:}SiO₂ is in a range of 40:60 to 100:0, and the second layer is made of SiO₂.
